(19) United States
(12) Patent Application Publication
(10) Pub. No.: US 2012/0066165 A1
(43) Pub. Date: Mar. 15, 2012

(54) TRACEROUTE DIAGNOSIS

(75) Inventor: James H. Drew, Pepperell, MD (US)

(73) Assignee: Verizon Patent and Licensing Inc., Basking Ridge, NJ (US)

(21) Appl. No.: 12/881,756

(22) Filed: Sep. 14, 2010

(51) Int. Cl. G06N 5/02

(52) U.S. Cl. 706/46

(57) ABSTRACT

A set of data obtained from a plurality of traceroutes is received in a computer. A set of variables indicating characteristics of the traceroutes is generated. The variables are used as input to a decision tree, the decision tree being configured to recursively partition the variables into groups according to respective round-trip times associated with the groups. Output is obtained from the decision tree reflecting an association of one or more network elements with a round-trip time.

BACKGROUND INFORMATION

A packet sent from a source node in a packet network generally traverses multiple nodes in the network to reach its destination node. It is possible to trace the route that a packet takes through the network, i.e., generate what is sometimes referred to as a “traceroute.” It is also possible to measure the round-trip time (RTT), sometimes also referred to as a latency, for a packet to be sent from a source node to a destination node, and then for a response to be sent from the destination back to the source. Sometimes round-trip times are higher than desired. For example, high round-trip times could be caused by flaws in hardware or software of a test computer being used to determine round-trip times, a time of day or date when a test is being conducted, a location of a computer from which a test is being conducted (, e.g., a metropolitan area, a state, etc.). Further, high round-trip times could also be caused by phenomena associated with a particular path through a network taken to transmit a packet, e.g., by a particular router, a particular port associated with a test computer, the quality of conductivity from one router to another, etc. Unfortunately, when RTT is higher than may be desired, difficulties may arise in isolating a possible cause responsible for the high RTT, e.g., due to large volumes of data and the many potential causes of high network latencies.

### BRIEF DESCRIPTION OF THE DRAWINGS

FIG. 1 illustrates an exemplary system for transporting packets in a packet switched network

FIG. 2 illustrates further exemplary details of the system of FIG. 1.

FIG. 3 illustrates an exemplary traceroute table showing first and second traceroutes.

FIG. 4 illustrates an exemplary decision tree analyzing traceroutes including the trace routes shown in FIG. 3.

FIG. 5 illustrates an exemplary process for applying a decision tree to identify characteristics of a network path that account for a round-trip time through the network path.

### DETAILED DESCRIPTION OF PREFERRED EMBODIMENTS

A decision tree may be created to provide a determination of a likelihood that one or more of a particular router, event, characteristic, etc. in a network is responsible for higher than desired round-trip times, or latencies, in the network. Variables may be created to represent various attributes of a network. For example, variables may indicate dates, times, etc. that a traceroute packet traveled through the particular router. Further, because the decision tree disclosed herein generally considers data at the traceroute level, and not at the level of individual hops, variables may be used to indicate, for a particular traceroute, whether the traceroute goes through the particular router. Thus, for a particular path through a network, e.g., a particular traceroute, a decision tree, by recursively partitioning a provided set of data, may be used to identify variables that are most likely associated with certain round-trip times, e.g., high or low round-trip times. For example, a decision tree may indicate that a particular router, a particular set of dates, time of day, or source computer, may be associated with higher round-trip times. Accordingly, network elements may be investigated, identified, and if warranted, repaired and/or replaced according to results provided from the decision tree.

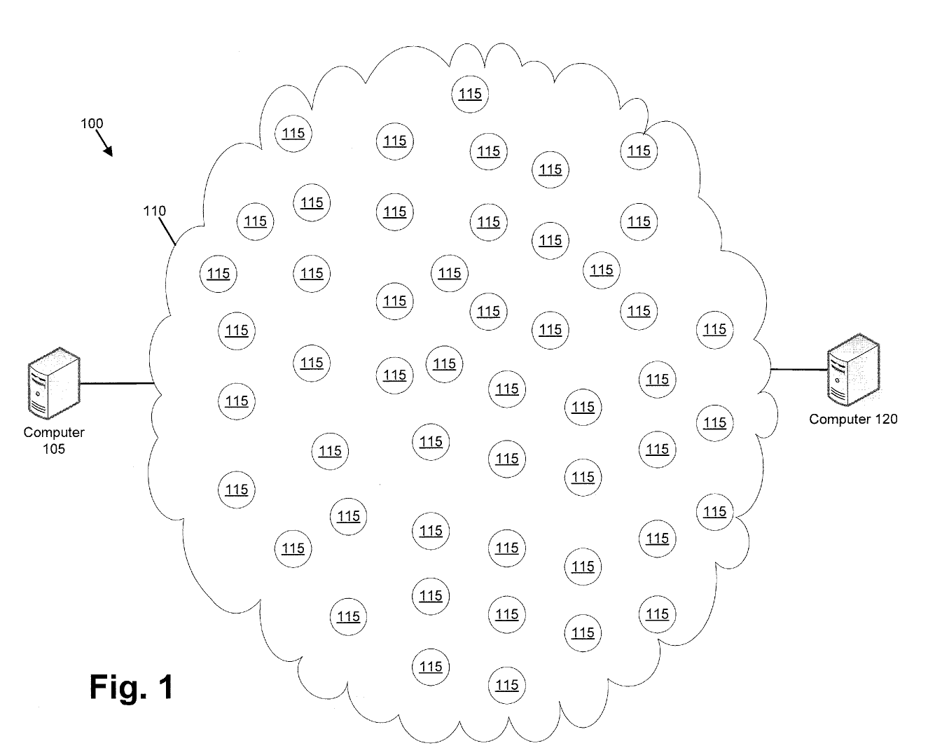

FIG. 1 illustrates an exemplary system 100 for transporting packets in a packet switched network 110. For example, the network 110 may operate according to Internet protocol (IP). Various routers 115 within the network 110 allow a first computer 105 to send packets to, and receive packets from, a second computer 120. The network 110 may be a local area network, wide area network, e.g., the Internet, or any other packet network that includes a plurality of routers 115. The routers 115 generally receive and forward packets from router to router in a conventional manner. Further, a packet traversing the network 110 generally travels for multiple hops, i.e., through multiple routers 115, when sent from a source computer 105 to a destination computer 120. Although not shown in the figures, the system 100 may include multiple source computers 105 and/or destination computers 120.

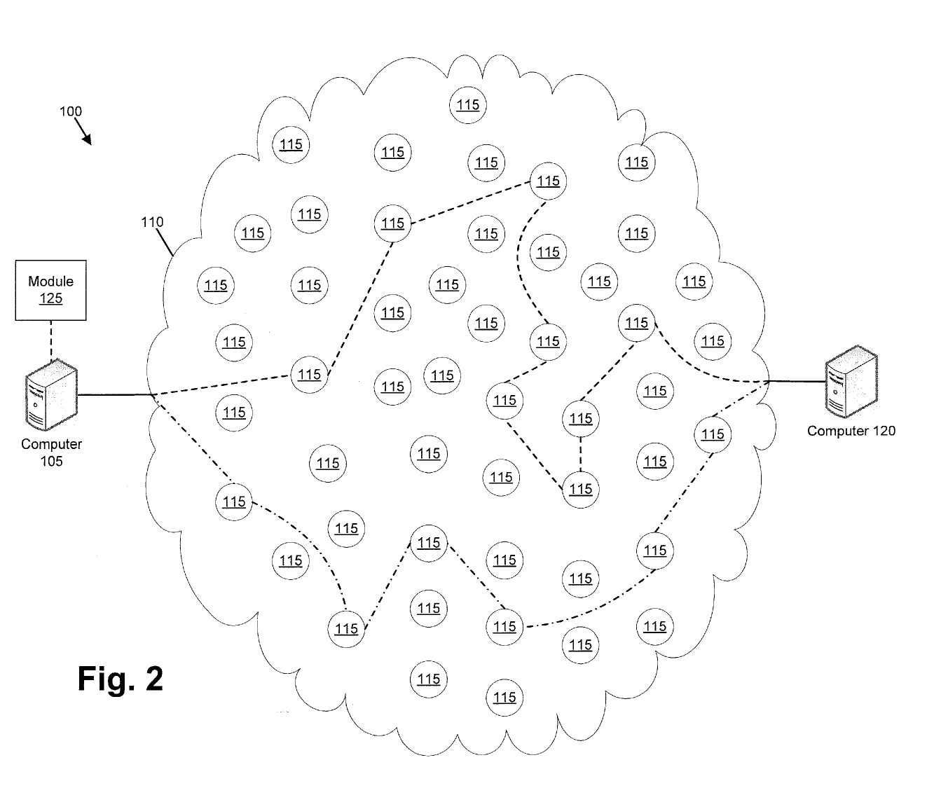

FIG. 2 illustrates further exemplary details of the system 100 of FIG. 1, including a module 125 that is included in the computer 105. In instances where the system 100 includes multiple computers 105, the module 125 may be included on one, or fewer than all of them. Alternatively, the module 125 could be included on some other computing device, so long as such computing device was provided appropriate input data as described below.

The module 125 may include instructions executable by a processor of the computer 105, and may be stored on a computer readable medium included in or accessible by the computer 105. The module 125 generally includes instructions that, when executed, allow for a determination of possible causes of higher than desired round-trip times of packets in the network 110. For example, the module 125 may include instructions for receiving a set of data, generating a set of variables based on the data, and then establishing and executing a decision tree that recursively partitions the data to identify network 110 elements and/or characteristics associated with particular round-trip times. Instructions included in the module 125 may include code written according to the R programming language and environment included in the Free Software Foundation's GNU project. At the time of this disclosure, more information about R may be found at http://www.r-project.org/. Of course, other programming mechanisms, including other statistical packages, could be used.

The dashed lines in FIG. 2 illustrates various possible paths from a source computer 105 to a destination computer 120 through the network 110. For example, the line having even dashes illustrates a first possible path through the network 110. The line having dashes of alternating longer and shorter lengths illustrates a second possible path through the network 110. Assume that the RTT associated with the first path is much shorter than the RTT associated with the second path. Use of a decision tree, as described herein, applied to data related to the second path may assist in determining structural reasons why the RTT associated with the second path is higher. More generally, for a multitude of paths through the network 110, a decision tree may be used to assess a large amount of data reflecting a multitude of traversals of the paths through the network 110 to identify network elements and/or characteristics potentially needing maintenance, replacement, and/or repair.

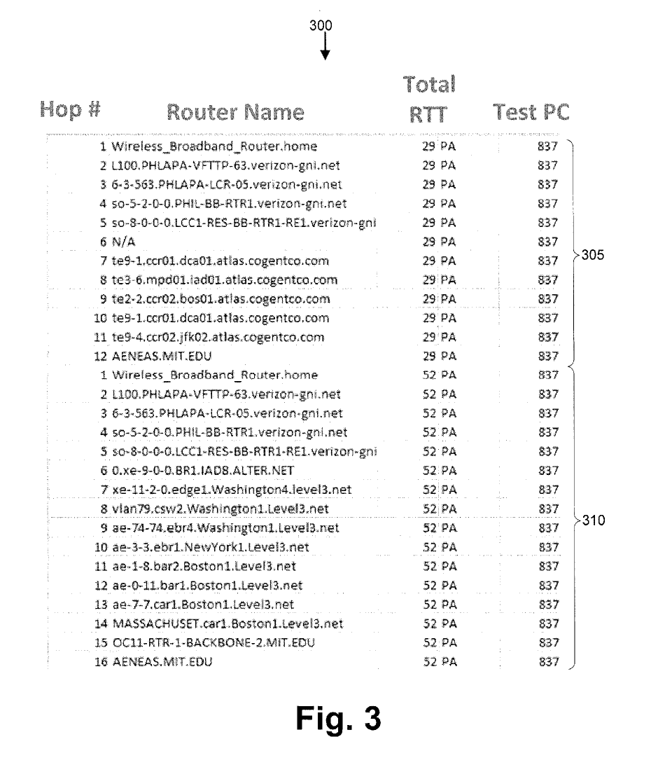

FIG. 3 illustrates an exemplary traceroute table 300 showing a first traceroute 305 and a second traceroute 310. As can be seen, the number of hops, and the particular routers traversed, are different in each traceroute, even though traceroutes 305 and 310 were conducted from a same test computer. Further, the “Total RTT” column provides, in milliseconds, a round-trip time associated with the respective traceroutes 305 and 310. The “Test PC” column indicates an identifier of a source computer 105 from which the traceroute was initiated. As can be seen, the RTT, or latency, associated with the traceroute 305 is a little more than half the RTT associated with the traceroute 310. Further, it does not appear that a difference in number of hops should account for the discrepancy. Therefore, it would be desirable to analyze data associated with the traceroute 310 to attempt to determine why the RTT associated with the traceroute 310 is relatively high.

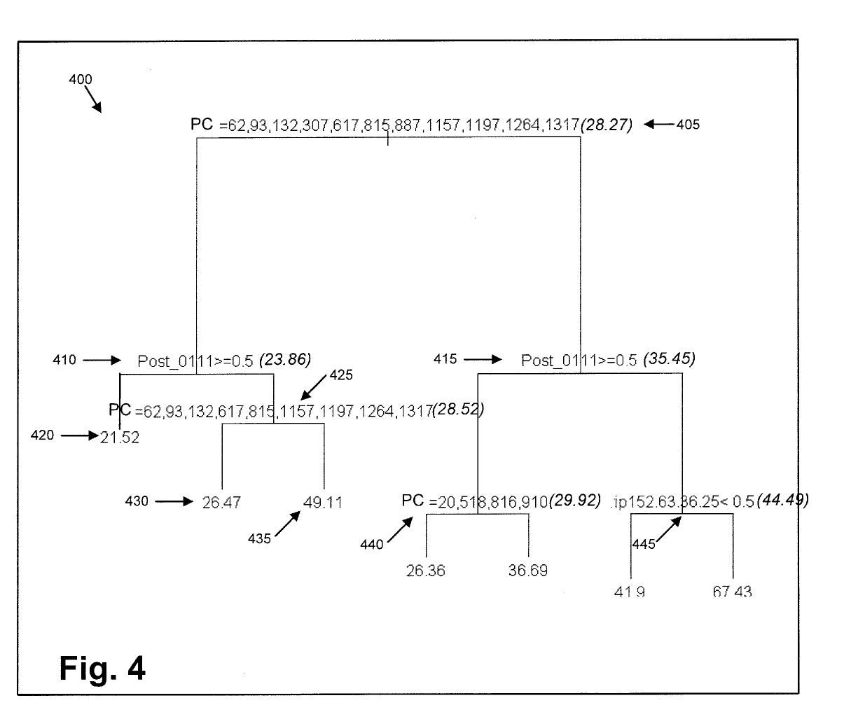

FIG. 4 is an exemplary illustration of a decision tree 400 analyzing certain traceroutes including the traceroutes 305 and 310 shown in FIG. 3. As explained above, the decision tree 400 recursively partitions data associated with a node. The decision tree 400 uses methods of statistical analysis to identify a variable whose values are used in partitioning the data. Variables may indicate characteristics of traceroutes. For example, variables may identify particular source computers 105, network routers 115 through which PCs have sent packets, dates and times when packets were sent, etc. the decision tree generally identifies variables whose different values are associated with different round-trip times. Put another way, an objective of the decision tree is to partition the data according to informative distinctions between round-trip times. That is, the decision tree seeks to determine useful associations with high RTTs and low RTTs. Then, once such associations are determined, potentially faulty network elements can be investigated, identified, and repaired or replaced.

The tree 400 includes a root node 405. The notation “PC” in the node 405, and throughout FIG. 4, refers to source computers 105 used to connect to a particular destination computer 120, sometimes referred to as a host. In this instance, data relating to computers 105 having the following identifiers was supplied to the decision tree 400: 20, 62, 93, 132, 307, 475, 518, 617, 815, 816, 837, 887, 910, 1157, 1197, 1264, 1317. Thus, the decision tree 400 generally operates on data obtained from hundreds, thousands, and even tens of thousands of traceroute. Further, the decision tree 400 generally operates on variables generated from such data, e.g., variables indicating characteristics of traceroutes such as whether a traceroute is associated with a particular router 115, a date or set of dates, a time of day, a computer 105, etc.

The italicized number in parentheses following the list of computers 105 in the node 405 is an average RTT, in milliseconds, for all traceroutes analyzed in the node 405.

For example, in the node 405 the italicized number, 28.27, is an average number of milliseconds of RTT to a destination 120 for all of the traceroutes from each of the computers 105 for which data was provided to the decision tree 400.

Note that the foregoing list of identifiers of computers 105 list includes identifiers that are not included in the list provided in the node 405. This is because each node indicates criteria according to which the node's data was partitioned. In the case of node 405, data supplied as input to the decision tree 400 was partitioned according to whether it was associated with any of the following computer 105 identifiers: 62, 93, 132, 307, 617, 815, 887, 1157, 1197, 1264, or 1317. That is, data relating to all of identifiers 20, 62, 93, 132, 307, 475, 518, 617, 815, 816, 837, 887, 910, 1157, 1197, 1264, and 1317 was supplied to the decision tree 400 in the example of FIG. 4, and following statistical analysis a determination was made that the data should be partitioned according to whether a round-trip time was or was not associated with computers 105 having identifiers 62, 93, 132, 307, 617, 815, 887, 1157, 1197, 1264, or 1317. According to a convention by which the rendering of the decision tree 400 is provided in FIG. 4, a first child node satisfying a condition specified in a parent node is depicted as far left on the tree 400 as possible, while a second child node not meeting the condition is depicted to the right of the first child node. Thus, as indicated in a child node 410 of node 405, data associated with identifiers 62, 93, 132, 307, 617, 815, 887, 1157, 1197, 1264, or 1317 for computers 105 indicates an average round-trip time of 23.86 milliseconds. Further, the child node 415 of node 405 indicates that data associated with remaining identifiers (computers 105 having identifiers 20, 475, 518, 816, 837, and 910) indicates an average round-trip time of 35.45 milliseconds.

Accordingly, a first partitioning of data in the tree 400 occurs with respect to the node 405. Specifically, the node 405 has two children, a node 410 and a node 415. Nodes 410 and 415 were generated, and partitioning of the node 405 was performed, according to whether data was associated with a computer 105 in a set of computers 105 identified as being associated with a lower RTT.

Looking at nodes 410 and 415, it can be seen that each was partitioned in turn according to whether data was associated with a traceroute performed on or after January 11, or before January 11. Note that, as discussed below, child nodes of a same parent node do not have to be partitioned according to a same rule, although this sometimes occurs because of the nature of the data presented. Here, data provided to the decision tree 400 yields the observation that there was a significant difference in average round-trip time before and after the date January 11.

Thus, the child node 420 of node 410 is associated with an average round-trip time of 21.52 milliseconds. The child node 425 of node 410, reflecting data associated with traceroutes conducted before January 11, indicates an average round-trip time of 28.52 milliseconds. No further partitioning is conducted with respect to node 420, i.e., the tree 400 has not determined any manner of partitioning the node 420 to separate data in the node 420 in a statistically meaningful manner, but node 425 is partitioned according to whether a computer 105 has one of the following identifiers: 62, 93, 132, 617, 815, 1157, 1197, 1264, or 1317. For these computers 105, node 430 indicates an average round-trip time of 26.47 milliseconds. Accordingly, node 435 indicates that computers 105 having identifiers 307 and 887 are associated with an average round-trip time of 49.11 milliseconds. Thus, the decision tree 400 has yielded potentially useful information that particular computers 105, i.e., those having identifiers 307 and 887, may be associated with relatively slow RTTs, i.e., high latencies.

The child node 415 of node 405 includes data not associated with computers 105 having identifiers 62, 93, 132, 307, 617, 815, 887, 1157, 1197, 1264, or 317. That is, the node 415 includes data associated with computers 105 having identifiers 20, 475, 518, 816, 837, or 910. As noted above, the node 415, like the node 410, was partitioned according to whether data was associated with on or after January 11, or before January 11. Accordingly, a child node 440 of the node 415 includes data associated with traceroutes conducted on or after January 11, while a child node 445 of the node 415 includes data associated with traceroutes before January 11.

The node 440 was partitioned according to whether data was associated with computers 105 having identifiers 20, 518, 816, or 910. If so, as indicated in a child node 450 of the node 440, such computers 105 were associated with an average round-trip time of 26.36 milliseconds. Other computers 105 considered in the node 440, i.e., the computers 105 having identifiers 475 or 837, are reflected in the node 455, indicating an average round-trip time of 36.69 milliseconds. Thus, again, the decision tree 400 has potentially identified computers 105 associated with higher round-trip times.

The child node 445 of the node 415 was partitioned according to whether data was NOT associated with an IP address of a router 115, specifically, the IP address 152.63.36.25. That is, child node 460 of the node 445 indicates an average round-trip time of 41.9 milliseconds, as opposed to an average round-trip time of 67.43 ms indicated in the child node 465. Thus, the decision tree 400 has yielded potentially useful information that a router 115, identified by the IP address 152.63.36.25, is associated with significantly slower RTTs. Therefore, investigation, analysis, and possible replacement of this router 115 may be indicated to improve RTT's through the network 110.

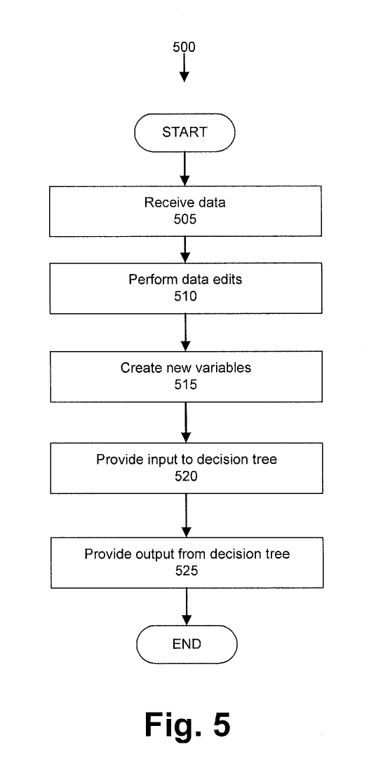

FIG. 5 illustrates an exemplary process 500 for applying a decision tree to identify characteristics of a network path that account for a round-trip time through the network path. The process 500 begins in a step 505, in which module 125 receives a set of data, e.g., provided on a computer readable medium, to be input to a decision tree 400.

Next, in a step 510, which is optional but is desirable in many situations, the data provided in step 505 is edited. For example, it may be desirable to execute step 510 for traceroute data which give incorrect RTTs to certain routers. For example, some traceroute packets may be unusually delayed or be given unusually low transit priorities.

Next, in a step 515, the module 125 automatically, i.e., according to computer-executable instructions included in the module 125, creates variables from the data provided in 505 for provision to a decision tree 400. For example, the module 125 may analyze each hop of each traceroute in a set of data and assign a binary value to a variable associated with the hop based on whether the hop goes through a particular router. Other variables may be created to indicate whether a traceroute is associated with a particular computer 105, a time of day, a date, etc. Variables created at the hop level are generally aggregated for a traceroutes, e.g., to the traceroute go through a particular router, was the traceroute performed at a particular time of day, or date, etc. Accordingly, a variable provided to decision tree 400 generally represents an aggregation for a traceroute, such as the numbers of times a particular router is transited.

Next, in step a 520, input is provided to decision tree 400. For example, a set of variables generated as described above, along with data identifying particular traceroutes associated with the variables, may be provided as input to the decision tree 400.

Next, in a step 525, output is provided from a decision tree 400. For example, output may appear as indicated above with respect to FIG. 4.

Following step 525, the process 500 ends.

As explained above, the output from the decision tree 400 may be used to take action with respect to one or more elements of the network 110, e.g., identify, maintain, repair, and/or replace network elements. Moreover, instructions for analysis of the output of decision tree 400 may be included in module 125. For example, module 125 could be configured to identify potentially slowest routers 115 by examining output of the decision tree 400, e.g., identifying routers 115 associated with latencies below a certain percentile. Similar analysis could be performed with respect to computers 105, dates, days of week, geographic areas, etc. Further, module 125 could be configured to automatically provide alerts, e.g., via e-mail, simple message service (SMS), etc., as well as reports, etc. relating to routers 115, computers 105, or other network elements flagged as associated with thresholds in output from a decision tree 200. Accordingly, module 125 may automatically take action based on output from a decision tree 200, e.g., sending an alert, or even removing a network element, such as a router.

Computing devices such as computer servers 130 and 140 may employ any of a number of computer operating systems, including, but by no means limited to, versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, laptop, or handheld computer, or some other computing device.

Computing devices such as servers 130 and 140, etc., generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Database 115 may be any of a variety of known RDBMS packages, including IBMS DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “an,” “the,” “said,” etc. should be read to recite one or more of the indicated elements unless a claim recites an explicit limitation to the contrary.

What is claimed is:

1. A method, comprising:
receiving, in a computer, a set of data obtained from a plurality of traceroutes;
generating a set of variables indicating characteristics of the traceroutes;
using the variables as input to a decision tree, the decision tree being configured to recursively partition the variables into groups according to respective round-trip times associated with the groups; and
obtaining output from the decision tree reflecting an association of one or more network elements with a round-trip time.

2. The method of claim 1, wherein characteristics of a traceroute include at least one of a router included on the traceroute, a date of the traceroute, a time of day of the traceroute, and a source computer for the trace route.

3. The method of claim 1, further comprising taking action with respect to at least one network element based on the output.

4. The method of claim 1, wherein the output from the decision tree includes associations of a plurality of network elements with a plurality of respective round-trip times.

5. The method of claim 1, further comprising editing the data prior to generating the set of variables.

6. The method of claim 5, wherein the editing includes removing data related to packets having a specified priority.

7. The method of claim 1, wherein the traceroutes were obtained from a plurality of source computers.

8. A system, comprising:
a computer configured to:
receive a set of data obtained from a plurality of traceroutes;
generate a set of variables indicating characteristics of the traceroutes;
use the variables as input to a decision tree, the decision tree being configured to recursively partition the variables into groups according to respective round-trip times associated with the groups; and
obtain output from the decision tree reflecting an association of one or more network elements with a round-trip time.

9. The system of claim 8, wherein characteristics of a traceroute include at least one of a router included on the traceroute, a date of the traceroute, a time of day of the traceroute, and a source computer for the trace route.

10. The system of claim 8, the computer further configured to take action with respect to at least one network element based on the output.

11. The system of claim 8, wherein the output from the decision tree includes associations of a plurality of network elements with a plurality of respective round-trip times.

12. The system of claim 8, the computer further configured to edit the data prior to generating the set of variables.

13. The system of claim 12, wherein the editing includes removing data related to packets having a specified priority.

14. The system of claim 8, wherein the traceroutes were obtained from a plurality of source computers.

15. A non-transitory computer-readable medium tangibly embodying computer-executable instructions including instructions for:
receiving, in a computer, a set of data obtained from a plurality of traceroutes;
generating a set of variables indicating characteristics of the traceroutes;
using the variables as input to a decision tree, the decision tree being configured to recursively partition the variables into groups according to respective round-trip times associated with the groups; and
obtaining output from the decision tree reflecting an association of one or more network elements with a round-trip time.

16. The medium of claim 15, wherein characteristics of a traceroute include at least one of a router included on the traceroute, a date of the traceroute, a time of day of the traceroute, and a source computer for the trace route.

17. The medium of claim 15, the instructions further comprising instructions for taking action with respect to at least one network element based on the output.

18. The medium of claim 15, wherein the output from the decision tree includes associations of a plurality of network elements with a plurality of respective round-trip times.

19. The medium of claim 15, the instructions further comprising instructions for editing the data prior to generating the set of variables.

20. The medium of claim 19, wherein the editing includes removing data related to packets having a specified priority.

21. The medium of claim 15, wherein the traceroutes were obtained from a plurality of source computers.
